(19) United States
(12) Patent Application Publication
(10) Pub. No.: US 2008/0007142 A1
(43) Pub. Date: Jan. 10, 2008

(54) Ultrasonic transducer assembly having a vibrating member and at least one reflector

(76) Inventor: Minoru Toda, Lawrenceville, NJ (US)

Correspondence Address: Plevy Howard, PC, P.O. BOX 226, Fort Washington, PA, 19034, US

(21) Appl. No.: 11/821,795

(22) Filed: Jun. 25, 2007

Related U.S. Application Data
(60) Provisional application No. 60/816,016, filed on Jun. 23, 2006.

(51) Int. Cl. G10K 11/28

(52) U.S. Cl. 310/335; 310/334

(57) ABSTRACT

An ultrasonic transducer assembly has a vibrating member which emits ultrasonic waves from a front side and a back side, a first reflector arranged to reflect the ultrasonic waves emanating from the back side of the vibrating member, and a second reflector arranged to reflect the ultrasonic waves emanating from the front side of the vibrating member. The first and second reflectors may be planar and arranged at an angle of about 45 degrees relative to a plane in which the vibrating member lies.

### RELATED APPLICATIONS

The present application claims the benefit of U.S. Provisional Patent Application Ser. No. 60/816,016, filed Jun. 23, 2006, which application is incorporated by reference herein in its entirety.

### FIELD OF THE INVENTION

The present invention relates to the field of ultrasonic transducers.

### BACKGROUND OF THE INVENTION

It can be appreciated that ultrasonic transducers have been in use for years. Some prior art ultrasonic transducers include a vibrating layer having a large area and a large power output. One application in the prior art for such transducers is in parametric array audio systems in which ultrasonic waves are used as carriers for propagating audio with sharp directivity. Other prior art applications of high power ultrasonic transducers with large area include range finders (long distance or SONAR), non-destructive interrogation of parts to identify internal defects, focused high power energy for ablation of biological substances and medical imaging.

A disadvantage of such prior art ultrasonic transducers is difficulty in generating high acoustic power output. In order to obtain enough power output, high voltage has to be applied and high current must flow into the large area transducer. With both a unitary piezoelectric film having a large area and transducers with multiple elements providing a large total area, power consumption is high, and high power amplifiers must be used to drive the transducers. High power amplifiers are expensive, heavy and bulky and consume large amounts of power. Furthermore, if the drive voltage exceeds the limits defined by the transducer material, the transducer may be damaged.

Another disadvantage of prior art ultrasonic transducers using PZT operated in thickness vibration mode is less energy efficiency with low output when a relatively broad bandwidth is desired. In an exemplary design of such transducers, an impedance matching layer is disposed on the front surface, i.e., the surface from which the acoustic wave is radiated, of the PZT, for the purpose of reducing reflection from the front boundary. When broad bandwidth is required, an absorber is added at the back surface to dampen the resonance. When high output is required with narrower bandwidth, a back absorber with lower impedance (lighter or less stiff material) is used and some or most of the acoustic wave emitted from the back surface is reflected at the back surface; the reflected wave is added to the wave emitted from the front surface, constructively in phase relationship. This results in a lower bandwidth. Thus, both broad bandwidth and high energy efficiency cannot be achieved in conventional thickness mode transducers.

A further disadvantage of such prior art ultrasonic transducers is the difficulty of controlling the directivity of generated audio signals. A parametric array audio system is a typical application of high power large area ultrasonic transducers, in which the ultrasonic wave is modulated by an audio signal and audible sound is generated by non-linearity during propagation of the ultrasonic wave. The generated audio wave can be heard mostly along the path of the ultrasonic wave and the directivity of audible sound is very sharp. However, the desired directivity, or spreading angle, is different depending on the particular desired application. For example, the desired directivity of an audible sound beam depends on the number of listeners at a specified distance from the speaker, while preferably rendering the audio inaudible at locations other than the desired listening locations. In some applications, it would be desirable to provide two ultrasonic beams generated by one item of equipment.

In the prior art technology, the diverging angle of the audio beam is determined by the size and area of the transducer. Wide angle systems use transducers having a relatively small area and narrow angle systems use large area transducers. Adjustment of the beam angle and the number of split beams can only be accomplished by modification of the design of the transducer, which cannot be done easily or quickly.

### SUMMARY OF THE INVENTION

One embodiment of the present invention includes an ultrasonic transducer assembly having a vibrating member and at least one reflector. The vibrating member emits ultrasonic waves from a front side and a back side. A first reflector may be arranged to reflect the ultrasonic waves emanating from the back side of the vibrating member, and a second reflector may be arranged to reflect the ultrasonic waves emanating from the front side of the vibrating member. The first and second reflectors may be arranged at an angle of about 45 degrees relative to a plane in which the vibrating member lies.

The first and second reflectors may be mounted to have an adjustable angle relative to a plane in which the vibrating member lies. The first reflector and second reflector may be so positioned to reflect both the acoustic wave emanating from the front side and the acoustic wave emanating from the back side toward a main propagation direction. The first and second reflectors may be so positioned relative to the vibrating member as to compensate for the phase difference between acoustic waves emitted from the front side and acoustic waves emitted from the back side. The first and second reflectors may have a concave surface facing the vibrating member so that the reflected waves are directed toward a focal point. The first and second reflectors may have a convex surface facing the vibrating member so that the reflected wave diverges.

In an embodiment, a vibrating member assembly has a vibrating member, having a metal layer and a layer of piezoelectric material on the metal layer; a frame supporting the vibrating member; a first conical radiator attached to a first side of the vibrating member; and a second conical radiator attached to a second side of the vibrating member.

In an embodiment, a vibrating member assembly has parallel and rigidly mounted ribs, the ribs being generally planar and parallel, and having generally parallel upper edges; a piezoelectric film bonded to and supported by the upper edges, the film curving intermediate the upper edges; surface electrodes on opposite surfaces of said film; and a peripheral frame supporting the ribs and the film, the frame being open to both sides of the film.

In an embodiment, a vibrating member assembly includes an electrostatic transducer having a polymer thin film; an electrode on one side of the film, and a metallic mesh on an opposite side of the film; and a peripheral frame supporting the transducer, the frame being open on both sides of the transducer.

In an embodiment, a vibrating member assembly has a thickness mode transducer, including a planar piezoelectric layer, a first impedance matching layer on one side of the piezoelectric layer, and a second impedance matching layer on an opposite side of the piezoelectric layer; and a peripheral frame supporting the transducer, the frame being open on both sides of the transducer.

### BRIEF DESCRIPTION OF THE DRAWINGS

FIG. 1 is a side view of an ultrasonic transducer assembly in accordance with an embodiment of the present invention having one vibrating member and two reflectors positioned at an angle of about 45 degrees relative to the vibrating member.

FIG. 2a-1 illustrates a diaphragm type vibrator of PZT bonded to a metal layer for use in a transducer assembly in accordance with an embodiment of the present invention.

FIG. 2a-2 illustrates a diaphragm type vibrator having conical radiators mounted on both the front and back thereof.

FIG. 2b illustrates a transducer utilizing curved polymer film clamped at each curved section with acoustic radiation emitted from both front and back surfaces.

FIG. 2c is a side view of a transducer utilizing corrugated polymer film with acoustic radiation emitted from both front and back surfaces.

FIG. 2d is a side view of an electrostatic type transducer with acoustic radiation from both surfaces.

FIG. 2e illustrates a thickness vibration type vibrator of PZT supported by a peripheral holder and having matching layers attached to both its front and back surfaces.

FIG. 3 is a side view of a transducer assembly in accordance with an embodiment of the present invention having reflectors at angles other than 45 degrees relative to the vibrator.

FIG. 4 is a side view of a transducer assembly in accordance with an embodiment of the present invention having reflectors at an angle of 45 degrees relative to the vibrator and no phase adjustment.

FIG. 5 is a side view of a transducer assembly in accordance with an embodiment of the present invention with concave reflectors.

FIG. 6 is a side view of a transducer assembly in accordance with an embodiment the present invention with convex reflectors.

FIG. 7 is a side view of a transducer assembly in accordance with an embodiment of the present invention having a transducer housing mounted to pivot.

FIG. 8a is an isometric view of a transducer assembly in accordance with an embodiment of the presenting invention.

FIG. 8b is an isometric view of the transducer assembly of FIG. 8a partially folded for transportation or storage.

FIG. 9A is a top view of an embodiment of a phased array transducer.

FIG. 9B is a side view of a transducer assembly incorporating the phase array transducer of FIG. 9A.

FIG. 9C is a schematic illustration of a control circuit for the phased array transducer of FIG. 9A.

### DETAILED DESCRIPTION OF THE INVENTION

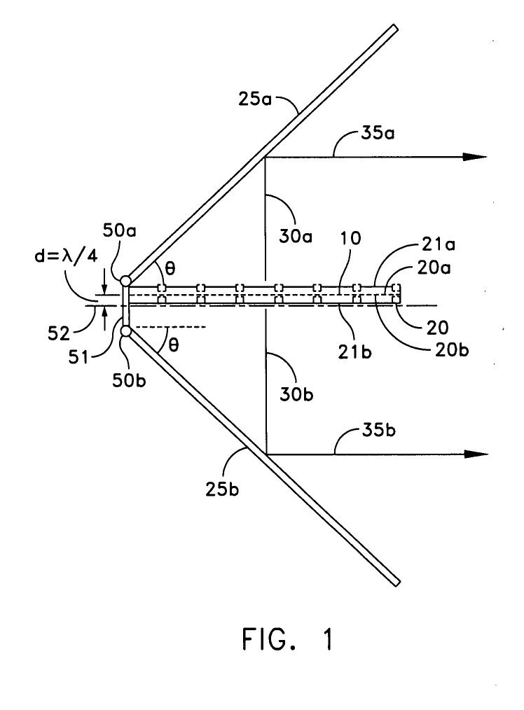

Referring to FIG. 1, transducer assembly 40, shown in a somewhat schematic side view, has vibrating member 10 supported and enclosed in a housing 20. Vibrating member 10 is generally flat and planar. Housing 20 may include a circumferential frame with open upper and lower sides 21a, 21b, which permit ultrasonic waves emitted by vibrating member 10 to pass, with little or no loss of energy. The impedance matching structure may be configured to obtain equal outputs for both waves 30a and 30b, which are represented schematically by lines.

The waves 30a and 30b are reflected by reflectors 25a and 25b respectively and redirected in the directions 35a and 35b. Reflectors 25a, 25b have planar faces toward housing 20. Reflectors 25a, 25b may have smooth surfaces and may be of rigid material, such as metal, PCB boards, or molded rigid plastic. Reflectors 25a, 25b are attached to base 51 through bearings 50a and 50b. Bearings 50a, 50b are bearings are mounted on base 51, and permit rotation of reflectors 25a, 25b, so that the angles of reflectors 25a and 25b relative to vibrating member 10 may be adjusted. Typically the beams 35a and 35b of the acoustic radiation after reflection are roughly in parallel.

Vibrating member 10 may be an array of discrete or separated units (particularly for piezoelectric ceramics such as PZT) or integrally formed by polymer piezoelectric film such as polyvinylidene fluoride (PVDF) or ferro-electret film (electromechanical film). Housing 20 may be of a rigid plastic.

Acoustic waves are generated by high frequency displacement of vibrating member 10 in the direction normal to surfaces 20a, 20b. The generated waves from first surface 20a and from second surface 20b have a phase difference of 180 degrees from one another. To compensate for this phase difference in reflected acoustic waves 35a, 35b, the vertical distance d between the vertical position of vibrating member 10 and the vertical midpoint 52 between reflectors 25a and 25b may be one quarter of the wavelength λ of the acoustic waves. The vertical direction is an axis perpendicular to a plane in which the vibrating member lies. Thus, compared to the phase of the wave 30a is 90 degrees in advance and the phase of 30b is in 90 degree lags. As a result the phase difference between the propagating wave 30a and wave 30b is 180 degrees; this difference compensates for the phase difference caused at the wave generation by the displacement of thin layer 10. Depending on the structure of the vibrating layer, waves emitted from the front side and wave emitted from the back side have exactly the same phase, and in such case, the vibrating layer may be positioned midway between the respective reflectors.

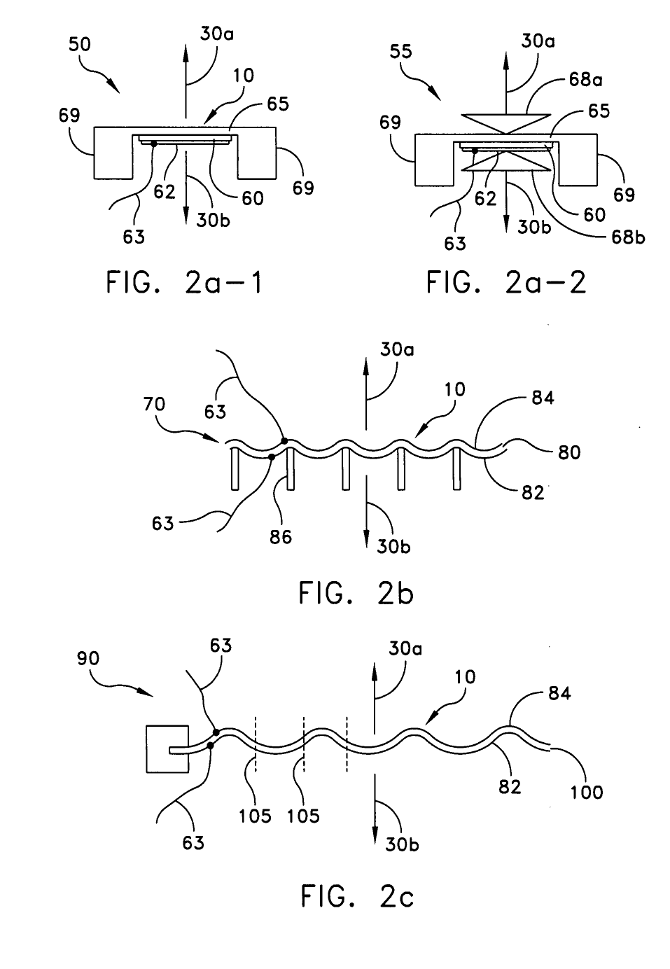

FIG. 2a, b, c, d, and e illustrate details of exemplary embodiments of vibrating members for use in ultrasonic transducer assemblies in accordance with embodiments of the invention. Alternative structures of vibrating members known in the art may also be employed. It will be appreciated that those of ordinary skill in the art are familiar with the physical mechanism of vibration.

FIG. 2a-1 illustrates a transducer structure 50, and FIG. 2a-2 illustrates a transducer structure 55. In both structures 50, 55, a thin layer of piezoelectric material, such as PZT layer 60, is bonded to metallic layer 65 to define a vibrating member 10, which is supported by peripheral frame 69. Alternating voltage is applied through lead 63 to surface electrode 62 on PZT layer 60. PZT layer 60 expands or shrinks in the planar direction but metallic layer 65 does not. The application of alternating voltage at lead 63 induces flexural vibration characteristic of a diaphragm type vibrator. The vibrating member radiates two acoustic waves 30a and 30b in opposite directions. In the embodiment of FIG. 2a-2, a conical shaped radiator 68a is attached at the center of the front side of vibrating member. A second conical shaped radiator 68b is attached at the back side of the vibrating member. In the embodiments illustrated in FIG. 2a-1 and FIG. 2a-2, the propagation medium may be a gas, such as air by way of example. An exemplary frequency range is from about 20 kHz to about 200 kHz. In an exemplary application, multiple units (100-500 units) of such transducers 50 or 55 may be aligned on a flat plane to form a large area transducer for use in a parametric array audio system.

FIG. 2b is a side view of a film transducer 70 which may be a vibrating member in accordance with an embodiment of the invention. Film transducer 70 includes film 80 having multiple curves, which may be PVDF film. Film 80 is bonded to and supported by each edge of multiple ribs 86. Ribs 86 are rigidly mounted on supports, which are not shown. Ribs 86 are not movable relative to one another. Film 80 has surface electrodes 82 and 84 on opposite surfaces thereof to which alternating voltage is applied through leads 63. Film 80 expands and contracts as the applied voltage changes. As film 80 is bonded to ribs 86, expansion and contraction induces displacement of film 80 in the direction normal to the surface of film 80. Thus two waves 30a and 30b are radiated in opposite directions. In the embodiment illustrated in FIG. 2b, the propagation medium may be gas, such as air by way of example. An exemplary frequency range is from about 20 kHz to about 200 kHz.

FIG. 2c is a side view of a corrugated film transducer 90, which may be an embodiment of a vibrating member of a transducer according to an embodiment of the invention. Corrugated film transducer 90 includes film 100, which may be PVDF film, which has surface electrodes 82 and 84 thereon. Alternating voltage is applied to electrodes 82, 84 via leads 63. Film 100 is formed into a generally corrugated shape, i.e., with alternating directions of curvature. Film 100 is held in position at multiple points (not shown), which define boundary lines 105. Film 100 expands and contracts with the alternating voltage, while boundary lines 105 do not move and the periodic expansion and contraction induces vibration normal to the surface of film 100, which results in ultrasonic radiation of waves 30a and 30b. In the embodiment illustrated in FIG. 2c, the propagation medium may be gas, such as air by way of example. An exemplary frequency range is from about 20 kHz to about 200 kHz. It should be noted that, for a corrugated transducer, that generated waves 30a and 30b are in the same phase. This phase relationship is a result of the symmetry of the transducer structure.

FIG. 2d is a side view of electrostatic transducer 110, which may be an embodiment of a vibrating member of an embodiment of the invention. Electrostatic transducer 110 has a polymer thin film 120 mounted on peripheral frame 126, between electrode 122 and metallic mesh 124. Bias dc voltage and a signal voltage are applied between electrode 122 and metallic mesh 124 and electrostatic force induces vibration of film 120 producing two acoustic waves 30a and 30b. In the embodiment illustrated in FIG. 2b, the propagation medium may be gas, such as air by way of example. An exemplary frequency range is from about 20 kHz to about 200 kHz. The polymer thin film may be polyester, for example.

FIG. 2e is a side view of thickness mode transducer 130, which may be an embodiment of a vibrating member in a transducer assembly in an embodiment of the invention. A thin planar central piezoelectric layer 140 is disposed between external layers 141a, 141b. Piezoelectric layer 140 expands or shrinks symmetrically when a voltage is applied. Piezoelectric layer 140 may be of ceramic in thickness vibration mode (PZT) or ferro-electret film (electromechanical film). External layers 141a and 141b having a symmetric structure may be selected to modify the resonance frequency or enhance the output performance. For example, an impedance matching layer may be provided to cause the resonance bandwidth to be broader. In the embodiment illustrated in FIG. 2e, if piezoelectric layer 140 is a ceramic, such as PZT, the propagation medium may be a liquid, such as liquid water, by way of example. An exemplary frequency range is from about 1 MHz to about 100 MHz for a ceramic piezoelectric layer in a liquid. In the embodiment illustrated in FIG. 2e, if the piezoelectric layer 140 is an electromechanical film, the propagation medium may alternatively be a gas, such as air, by way of example. An exemplary frequency range is from about 20 kHz to about 200 kHz for an electromechanical film in a gas.

The selection of impedance matching materials for external layers 141a and 141b is within the capability of one of ordinary skill in the art. By way of example, if a relatively low impedance is desired, a material such as polyethylene or polyurethane may be employed. If a relatively high impedance is desired, a material such as such as polyester or metal may be employed. By way of further example, the materials disclosed in my prior U.S. Pat. No. 6,307,302, which patent is incorporated herein by reference in its entirety, may be employed to provide impedance matching layers.

In prior art transducers of ceramic, such as PZT, in thickness mode, some part of the output to the back side is reflected by a back boundary and then transmitted past the front side of the transducer; the transmitted portion is constructively added to the output directly from the front side. However, this results in a relatively narrow bandwidth, and loss of energy due to reflection. An advantage of the transducer assembly of FIG. 2e, which outputs waves to the back side and has impedance matching layers on both sides of the piezoelectric layer, in an assembly as disclosed herein having one or more reflectors, is that the bandwidth is greater and there is improved energy efficiency. The use of an impedance matching layer at both sides obtains relatively broad bandwidth and high energy efficiency simultaneously.

When a transducer in accordance with an embodiment of the invention is used in a parametric array audio system, the position shift d=λ/4 mentioned above in connection with FIG. 1 and FIG. 2, may not be necessary in order for the audio output waves to be in phase. This is because the phase of generated audio is proportional to the power of the ultrasonic wave. When an ultrasound beam propagates and the intensity varies in time by modulation, positive acoustic pressure of the audio signal is generated in the region of strong ultrasonic waves, and negative acoustic pressure of the audio signal is generated in the region of weaker ultrasonic waves. Accordingly, referring to FIG. 1, if d=0, so that the reflectors are positioned symmetrically relative to the transducer, even when the two ultrasonic waves from reflectors 25a and 25b are out of phase, the power from ultrasonic beams 35a and 35b varies exactly in the same way. For example, when the power of beam 35a increases, the power of beam 35b also increases. Therefore, the audio signals generated from ultrasonic beams 35a and 35b are in the same phase and enhance each other during propagation. Of course, even if two ultrasonic waves of beam 35a and 35b are in phase, the reflector system generates similar strong audio waves. In other words, in parametric audio systems, the adjustment of the relative phase of the ultrasonic wave emitted from the back and front of the vibrating member, respectively, (d value), does not play a crucial role.

As shown in FIG. 1, two reflectors 25a, 25b are arranged at an angle of approximately 45 degrees relative to the vibrating layer. Both front wave 30a and back wave 30b are redirected by reflection to the main propagation direction. Referring to FIG. 1, the ultrasonic waves 30a and 30b are in the direction normal to the vibrating layer 10 and reflectors 25a and 25b redirect the waves 30a and 30b towards the directions 35a and 35b. The typical value of angle θ between reflector 25a and vibrating member 10, and between reflector 25b and vibrating member 10, is 45 degrees. Where the value of θ is 45 degrees, the plane of vibrating member 10 is parallel to the main propagation direction indicated by at 35a and 35b. The two beams indicated at 35a and 35b propagate in the same direction and together form one beam with a larger cross sectional area than either beam 30a or beam 30b. Both the beam energy spread at a certain large distance and both waves are superposed so that the beam intensity is at a maximum at the central propagation axis of the reflector system.

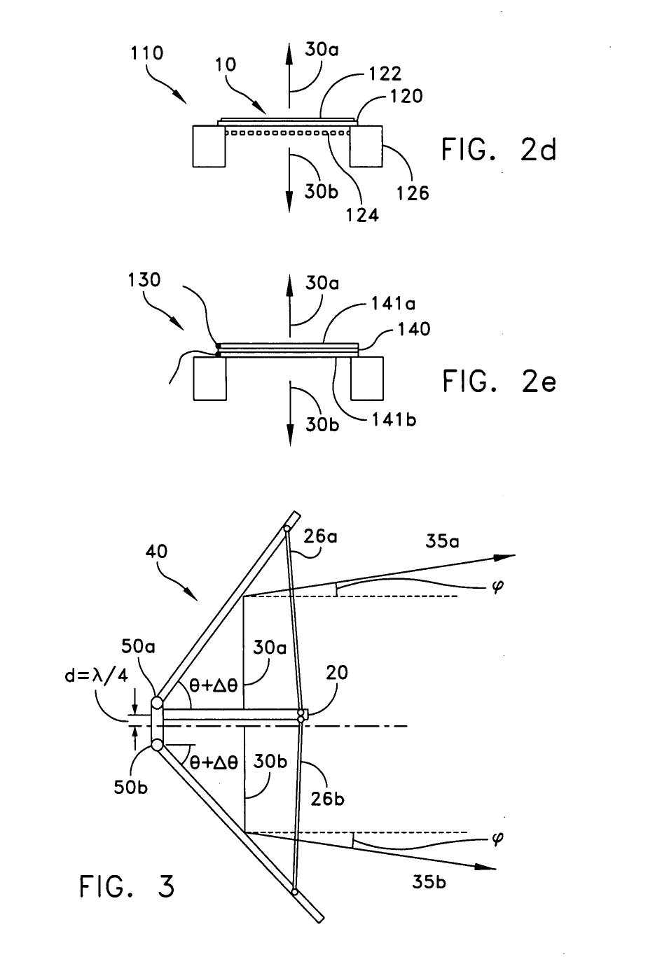

Depending on the application, the beam directions 35a and 35b may not be parallel. Referring to FIG. 3, transducer assembly 40 is shown in a configuration in which the angle of reflectors 25a, 25b relative to vibrating member 10 is selected so that the propagation angle of reflected beams 35a, 35b is deviated by angle φ parallel to the vibrating member. In this case, according to the reflection law the angle between the vibrating member and each reflector deviates by Δθ from 45 degrees, satisfying a relationship of Δθ=φ/2. The values φ and Δθ can be positive, in which case the assembly has the configuration shown in FIG. 3, and the beams 35a, 35b spread apart as they propagate. Those values may in the alternative be negative, in which case the reflected beams 35a, 35b intersect. In the case of a parametric array audio system for super high directive sound beams, if the condition of φ=0 results in a beam that is too sharp, spreading beams are created by configuring transducer assembly 40 with a positive value of φ. As a result, the beams 35a, 35b from the two reflectors may propagate in two different directions. Reflectors 25a and 25b may be connected to an end of housing 20 so as to be able to rotate relative to housing 20, by way of example by hinges 50a and 50b, so that the direction of reflectors 25a and 25b can be varied. Thus, the spreading angle of beams can be readjusted depending on the practical requirement. Hinges 50a and 50b are made by mounting suitable bearings, for example.

After the reflectors 25a, 25b have been moved to a selected angle, the angle may be fixed by adjustable bars 26a and 26b. The bars 26a and 26b are attached to housing 20 at one end, and at the other end to reflectors 25a, 25b, respectively. Bars 26a, 26b may be connected, by way of example, by a pin with a bar attached at the housing 20. Bars 26a, 26b may be pivotally connected to housing 20 and to the respective reflectors 25a, 25b. The position of the ends of bars 26a, 26b, attached to reflectors 25a, 25b, may be changed in order to change angle φ. Alternatively, the angle φ may be adjusted by changing the length of the bars 26a and 26b, each of which may be composed of inner and outer pipes, which may be assembled in a telescoping arrangement or by a screw fitting to render the length of bars 26a, 26b adjustable. It will be appreciated that many other structures may be provided to adjust and fix the angles of reflectors 25a, 25b.

As already described in FIG. 1, the location of the transducer element may be adjusted to compensate for the phase difference of front and back waves. Referring to FIG. 2a, b, c and d, the structure of vibrating layer 10 displaces in the direction normal to the surface without changing its thickness. The vibration generates two waves that are, for many vibrating layers, out-of-phase. If the vibrating layer is a corrugated transducer, such as that shown in FIG. 2c, the two waves are in phase. However, if the position of the vibrating layer does not change, but the thickness of the vibrating layer varies in time (as in a thickness vibration), then acoustic radiation from the front and back surfaces is in phase. Then the position difference d between the midpoint between the reflectors and the vibrating layer (shown in FIGS. 1, 3, 5 and 6) may be zero.

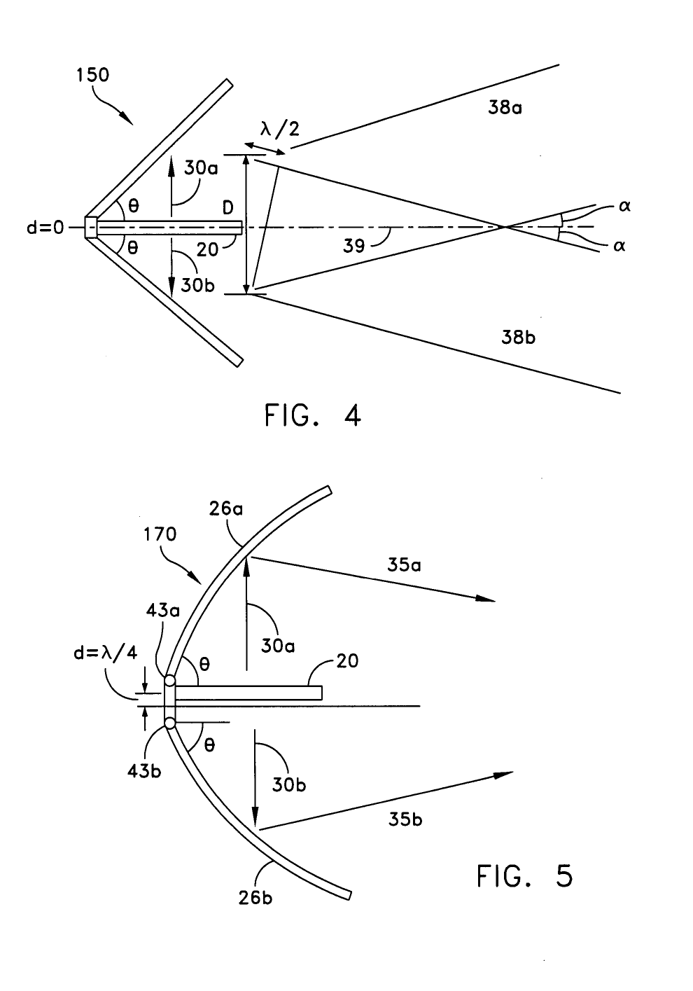

Referring to FIG. 4, an embodiment of a transducer assembly 150, similar to the transducer assembly of FIG. 1, is shown. In transducer assembly 150, the position shift d of the transducer element is zero. The first and second surfaces of a vibrating member radiate two acoustic waves 30a, 30b with opposite phase relationship. Reflector angle θ is chosen to be exactly 45 degrees for both reflectors. The reflected beams are indicated by 38a, 38b. Reflected beams 38a, 38b are generally parallel to center line 39, and diverge slightly. For ease of illustration, the divergence of reflected beams 38a, 38b is greatly exaggerated. In the region of center line 39, diverging portions of reflected beams 38a, 38b intersect; in this location, as the phase difference of the two reflected beams is 180 degrees, the beams cancel each other. Reflected beams 38a, 38b, diverge to a greater or lesser extent. At a very long distance from transducer assembly 150, beams 38a, 38b at the central axis 39 cancel each other because the phases of two beams differ by 180 degrees. However, beams 38a, 38b form two strong beams that deviate from center line 39 by angle α. The angle is defined by α=arcsin λ/2D where D is the center to center distance of the reflectors and λ is the wavelength (=propagation velocity divided by the frequency). By way of example, the value of α is 0.986 degrees for a frequency of 50 kHz, a wavelength λ of 6.88 mm, and a center to center distance between reflectors D of 20 cm. In this example, because the angle α is so small, the two relatively strong beams, with an acoustic field of minimal strength at the center along central axis 39, can be observed only at a distance more than about 5 meters from the transducer assembly 150.

The assembly illustrated in FIG. 4 may be used, by way of non-limiting example, in a parametric array audio system in which the ultrasonic wave modulates an audio signal and the audio signal is demodulated during propagation. At a large distance from the assembly, the ultrasonic beam is made up of two beams with angle of ±α. When D is large and λ/2 is much smaller than D, the split angle α becomes very small as mentioned above, and the two audio waves generated by two ultrasonic beams are mixed in-phase condition; the directivity of the generated audio is still very sharp and it is difficult to notice the difference in output between an assembly, such as that of FIG. 4, where d=0 and a structure where the vibrating member is displaced from the center 39 by one-quarter wavelength, i.e., where d=λ/4. It should be noted that the generated audio waves by both beams with angle of ±α have the same phase and are constructively added during the propagation of audio waves.

Referring to FIG. 5, an assembly 170 is shown in which both reflectors 26a, 26b are slightly curved, having a concave shape. Each reflected beam propagates toward a focal point determined by the form of each reflector. The focal points of the two reflectors may be chosen to be a common focal point. Non-limiting examples of use of such an assembly include parametric array audio systems, non-destructive interrogation of internal defects, focused high energy systems for abrasion of biological organs, and medical imaging.

For a parametric array system, such a concave reflector focuses the ultrasonic beam. As compared to a system employing planar reflectors, the demodulated audible sound propagates with much sharper directivity at a relatively short distance, and spreads further at a greater distance. Each concave reflector 26a, 26b has its own focal point. Whether these two focal points are at two different two points or at a single point depends on the orientations of the two reflectors 26a and 26b. If the reflectors 26a, 26b are oriented so that the focal points are separate, in a parametric audio system, two persons at different locations may be able to hear the sound. Reflectors 26a and 26b may be attached to an end of housing 20 by hinges 43a and 43b, for example. Thus, reflectors 26a, 26b may be rotated so as to adjust the spreading angle of the reflected ultrasound beams.

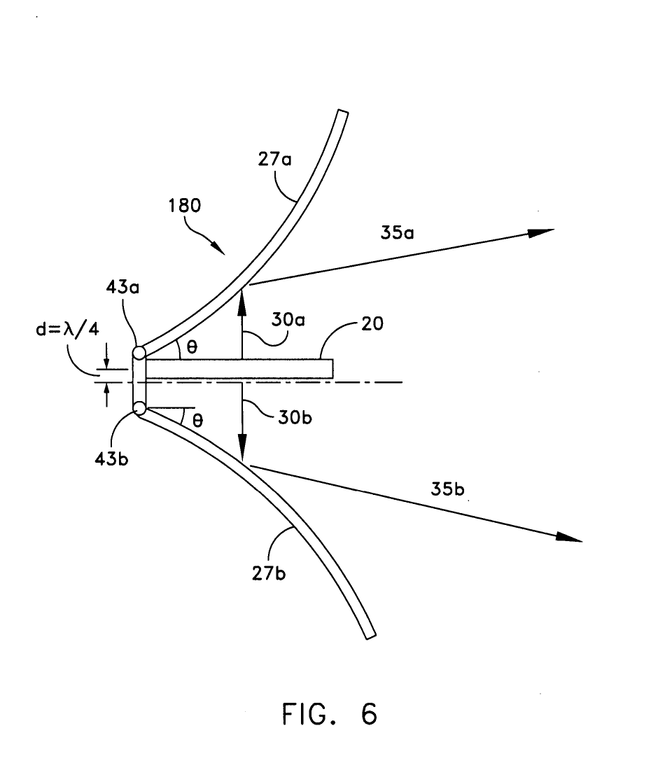

Referring to FIG. 6, there is illustrated a transducer assembly 180 having convex reflectors 27a and 27b. The reflected beam diverges, and the extent of divergence depends on the curvature. Such diverging beams are desirable, for example, if a relatively large number of people are listening to the sound generated by a parametric array system. The curvature of convex reflectors 27a and 27b determines the spreading angle of each beam reflected from reflector 27a or 27b. Depending on the practical requirement, the spreading angle may be readjusted. Attaching convex reflectors 27a and 27b to end of housing 20 by use of hinges 43a and 43b, the directions of reflectors 27a and 27b can be varied by rotating the reflectors 27a and 27b. Thus, the spreading angle of beams can be readjusted depending on the requirement.

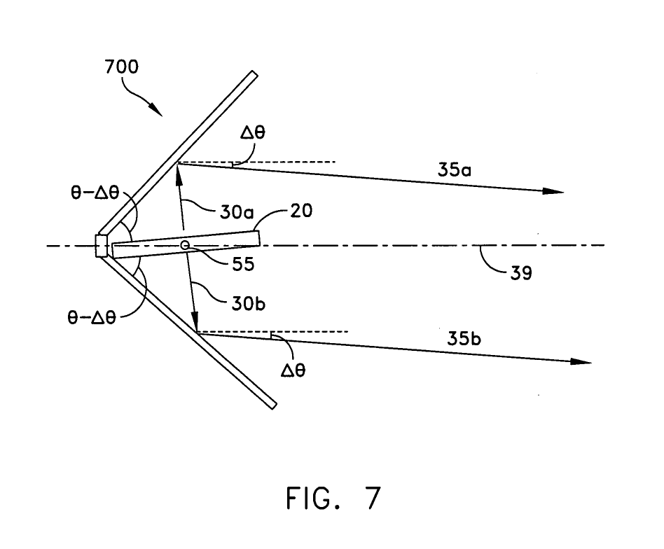

Referring to FIG. 7, there is shown a transducer assembly 700 having transducer housing 20 mounted on pivot 55. As the orientation of transducer housing 20 and the transducer contained therein is changed, the beam direction can be changed. As seen in FIG. 7, transducer 20 has been rotated from parallel to axis 39 by angle Δθ. Accordingly, the direction of reflected beams 35a, 35b is shifted by Δθ from parallel to axis 39. An advantage of the structure of FIG. 7, when compared to a structure in which the entire transducer assembly is mounted to rotate, is that a pivot structure sufficient to rotate the transducer housing 20 may be less expensive than a structure on which the entire transducer assembly may pivot. When the beam direction is deviated from parallel to the central axis, the propagation path length of the ultrasonic beam to a single object is different for the two beams, and the phase relationship is varied. For parametric array audio system, this phase difference in the ultrasonic waves does not influence the beam pattern of the audio waves, and just the audio beam direction is adjusted.

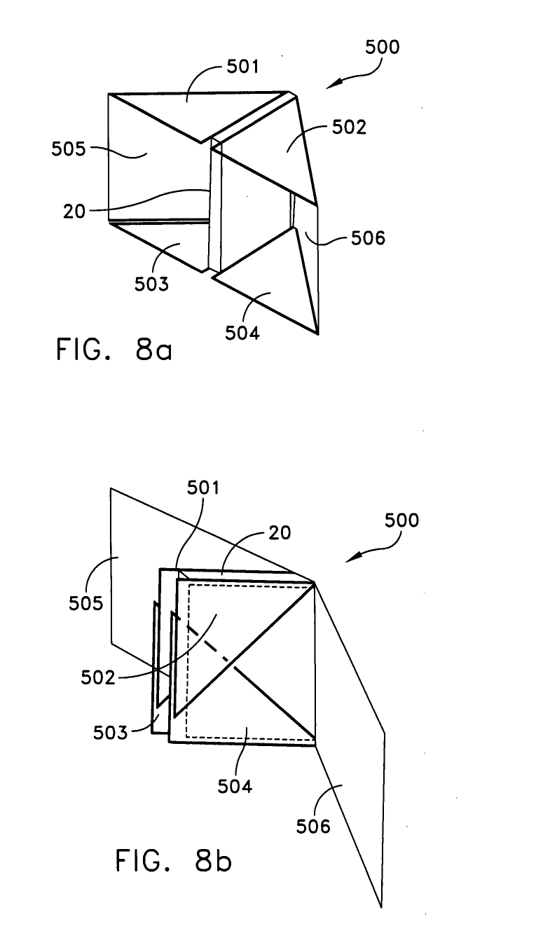

FIG. 8a shows a transducer assembly 500 configured for use. Transducer assembly 20 is centrally located, with reflectors 505, 506 mounted outward relative to transducer assembly 20. Triangular plate 501 is attached at an upper edge of housing 20 and reflector 505. Triangular plate 503 is attached at a lower edge of housing 20 and a lower edge of reflector 505. Triangular plates 501, 503 tend to maintain reflector 505 at the proper angular position relative to housing 20. Similarly, triangular plate 502 is attached at an upper edge of housing 20 and an upper edge of reflector 506. Triangular plate 504 is attached at a lower edge of housing 20 and a lower edge of reflector 506. Triangular plates 502, 504 tend to maintain reflector 506 at a proper angular position relative to housing 20. It will be appreciated that each triangular plate 501, 503, 504, 506 is substantially rigid. It will also be appreciated that the shape of triangular plates 501, 503, 504, 506 may be varied. By way of example, a substantially rigid member extending between and attached at or substantially at an upper edge of housing 20 and at or substantially at an upper edge of reflector 505 may be employed. Similar substantially rigid members may be deployed for the other disclosed triangular plates. The attachments between the substantially rigid members and the reflectors may be detachable and re-attachable. The substantially rigid members may be pivotally attached to the housing 20.

Referring to FIG. 8b, transducer assembly 500 has been partially folded, such as for transport or storage. Triangular plates 502, 504 are no longer attached to reflector 506, and have been moved to be adjacent housing 20. Similarly, triangular plates 501, 503 are no longer attached to reflector 505, and have been moved to be adjacent housing 20. Reflectors 505, 506 may be folded over the triangular plates to complete folding of transducer assembly 500.

In an alternative embodiment, a phased array of thickness mode transducers, such as those illustrated in FIG. 2e, may be provided. Either a one-dimensional array, or a two-dimensional array, which may be planar, may be provided. A two-dimensional array may be a square array, with the same number of transducers, or elements, in each direction, or may have more elements in one direction than in another. In a two-dimensional array, the two axes may be perpendicular to one another, or may be at a different angle. A two-dimensional array has at least four elements, and may have many more than four elements. A one-dimensional array has at least two elements, and may have many more than two elements. Phase-separated drive signals may be provided, by techniques well known by those of skill in the art, to drive the transducers of the phased array. As is well known, the beam direction may be controlled. In this alternative embodiment, the beam direction from both the front side and the back side are controlled. The beams are reflected by reflectors, such as those illustrated in the figures, to be output in the same direction of propagation, and the two beams output by the phased array are added.

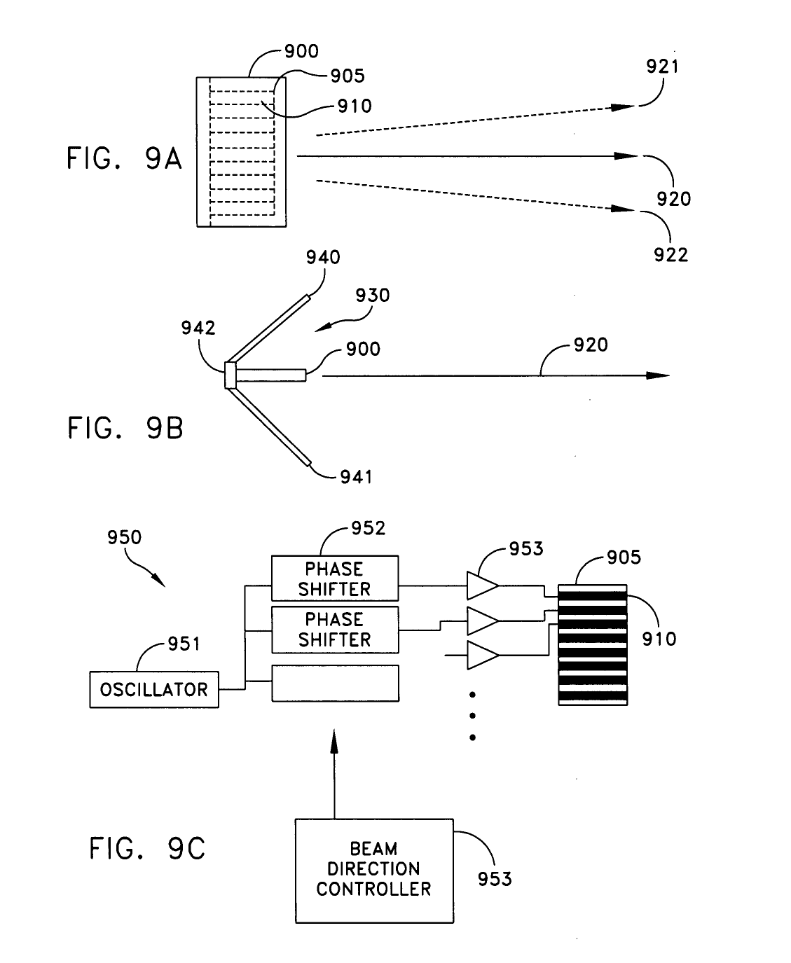

Referring to FIG. 9A, a top view of an embodiment of a phased array transducer 900 is shown. Array 905 is disposed on phased array transducer 900. Array 905 is a one-dimensional array, having transducer elements 910. Elements 910 may be arranged in a plane in array 905. Elements 910 may be identical to one another. Elements 910 may be, by way of example, thickness type transducers as illustrated and described with respect to FIG. 2e above. The particular number of elements 910, and their shape, is merely exemplary. There may be more or fewer elements 910, and they may have a different shape. Array 905 may alternatively be a two-dimensional array. FIG. 9A also illustrates exemplary beam paths 920, 921, 922. It will be appreciated that the beam direction may be altered by the signal driving the array elements. The beam direction need not be normal to the plane of array 905. Both the front and back sides of phased array transducer 900 are open to permit beams to exit.

Referring to FIG. 9B, a phased array transducer assembly 930 is shown. Phased array transducer 900 serves as a vibrating element of phased array transducer assembly 930. Assembly 930 includes reflectors 940, 941, which reflect waves emitted from the front and back side of phased array transducer 900. Base 942 supports phased array transducer 900 and reflectors 940, 941. An output beam 920 is shown, which is the sum of the reflected beams from the front and back sides of phased array transducer 900. As the beams from the front and backs sides of the phased array are changed, the direction of output beam 920 is also changed.

FIG. 9C is a schematic illustration of a control circuit providing driving signals to the transducers 910 of array 905. Oscillator 951 provides a signal, such as a sinusoidal signal, to phase shifters 952. A phase shifter 952 is associated with each transducer 910. Beam direction controller 953 provides a control signal to phase shifters 952. Phase shifters 952 output a phase shifted oscillating signal. Amplifiers 953 may be interposed between the phase shifters 952 and the corresponding transducers 910. The phased array then outputs a beam in a direction determined by the phase shift.

The direction of propagation of a phased array may be altered by control of the drive signals, and may or may not involve mechanical movement of reflectors relative to the transducers, in addition to control of drive signals. It will be appreciated that, in the illustrated embodiments lacking a phased array, the beam propagates normal to the plane of the vibrating element. In a phased array, the beam may propagate in any direction with respect to the plane of the vibrating element.

It will be appreciated that the cross sectional area of an ultrasonic beam radiating from a transducer necessarily diverges so as to have a wavefront having an area greater than the area of the transducer. Therefore, the planar area of each reflector may extend over more than the cross sectional area of the vibrating member.

As noted above, the position of the vibrating member may be off the central axis of the transducer assembly by a distance d, where d=λ/4, to provide a difference in path length of one half the wavelength of the acoustic radiation (λ/2) between the beam emitted by the front of the vibrator and the beam emitted by the back of the vibrator. It should be noted that the path difference may be the product of any integer and the wavelength, divided by 2. The average distance from the vibrating member to the first reflector may be an integer multiple of half wavelength different from the average distance from the vibrating member to the second reflector. To obtain a relatively small transducer assembly, the difference in the distances may be one-half the wavelength. In some transducers in MHz region, the wavelength is so short that the smallest practical integer N may be more than 1.

All the reflectors shown in FIGS. 1, 3, 5 and 6 may be rectangular, or may have a different shape. By way of example, the reflectors may have an oval shape. By way of example a small transducer assembly as disclosed herein may be mounted inside of a small pipe, for example, inside of a pen, and an ultrasonic wave propagates along the axis of the pipe and exits at an end of the pipe. Such an arrangement may be used as an ultrasonic pen position locator; if combined with a computer, patterns or letters reflecting movement of the pen, such as by hand, may be displayed on a computer display. For this application, oval shaped reflectors fit in a pen; the longer axis of the oval coincides with the axis of the pen. The ultrasonic wave may be focused at an exit point; an advantage of this arrangement is that the transducer assembly of an embodiment of the present invention permits a wave to be accurately directed through a passageway with a small cross sectional area. The propagation medium may be air or water, for example. An example of a use in water is SONAR, where a transducer is in a body of water, such as a lake or ocean, and the timing of received acoustic pulse echo is used to determine distance from an object (such as the bottom or a fish) to the transducer. An assembly in accordance with an embodiment of the present invention is advantageous as providing output with strong acoustic power has to be launched with lower power consumption, and within the limit of applicable drive voltage, as compared to the prior art.

An advantage of a transducer in accordance with an embodiment of the present invention, as compared to prior art ultrasonic transducers, is that while prior art ultrasonic transducers utilize the acoustic wave energy emanating from only one surface of the vibrating member, a transducer in accordance with an embodiment of the present invention utilizes the acoustic wave energy emanating from both sides of the vibrating member.

While the present invention has been described with reference to the disclosed embodiments, it will be appreciated that the scope of the invention is not limited to the disclosed embodiments, and that numerous variations are possible within the scope of the invention.

What is claimed is:

1. An ultrasonic transducer assembly, comprising:
a vibrating member having a front side and a back side, the vibrating member being adapted to emit ultrasonic waves from the front side and the back side; and
a first reflector arranged to reflect the ultrasonic waves emanating from the front side of the vibrating member.

2. The assembly of claim 1, further comprising a second reflector arranged to reflect the ultrasonic waves emanating from the back side of the vibrating member.

3. The assembly of claim 1, wherein said vibrating member lies in a plane; said first reflector is planar and at an angle of about 45 degrees to the plane of the vibrating member, and said second reflector is planar and at an angle of about 45 degrees to the plane of the vibrating member.

4. The assembly of claim 1, wherein said first reflector is pivotally mounted relative to the vibrating member.

5. The assembly of claim 4, further comprising a second reflector arranged to reflect the ultrasonic waves emanating from the back side of the vibrating member, said second reflector being pivotally mounted relative to the back side of the vibrating member.

6. The assembly of claim 2, wherein the first reflector is positioned to reflect the ultrasonic waves emanating from the front side of the vibrating member in a main propagation direction, and the second reflector is positioned to reflect the ultrasonic waves emanating from the back side in the main propagation direction.

7. The assembly of claim 6, wherein the first reflector, second reflector and vibrating member are so positioned relative to one another that, when reflected in the main propagation direction, the ultrasonic waves from the front side and the ultrasonic waves from the back side are in phase with one another.

8. The assembly of claim 7, wherein said vibrating member lies in a plane, a distance along an axis perpendicular to the plane between a position of the vibrating member and a midpoint between the first and second reflectors is one quarter of the wavelength of the ultrasonic waves emanating from the vibrating member.

9. The assembly of claim 2, wherein the first and second reflectors each have a concave surface facing the vibrating member.

10. The assembly of claim 2, wherein the first and second reflectors each have a convex surface facing the vibrating member.

11. The assembly of claim 5, wherein said vibrating member has a housing, said assembly further comprising a first bar attached to said first reflector and to said housing, and a second bar attached to said second reflector and said housing.

12. The assembly of claim 11, wherein said first and second bars are of adjustable length.

13. The assembly of claim 2, wherein said vibrating member has a housing, said housing being pivotally mounted, whereby said vibrating member may pivot relative to said first and second reflectors.

14. The assembly of claim 2, wherein said vibrating member has a housing, said assembly further comprising: a first substantially rigid member attached substantially to an upper edge of the housing and substantially to an upper edge of the first reflector; a second substantially rigid member attached at substantially at a lower edge of the housing and substantially at a lower edge of the first reflector; a third substantially rigid member attached substantially at an upper edge of the housing and substantially at an upper edge of the second reflector; and a fourth substantially rigid member attached substantially at a lower edge of the housing and substantially at a lower edge of the second reflector.

15. The assembly of claim 14, wherein each of said substantially rigid members is a triangular plate.

16. The assembly of claim 15, wherein said first and second triangular members are detachably attached to said first reflector, and wherein said third and fourth triangular members are detachably attached to said second reflector, and wherein each of said triangular members is pivotally attached to said housing.

17. A vibrating member assembly, comprising:
a vibrating member, comprising a metal layer and a layer of piezoelectric material on the metal layer;
a frame supporting the vibrating member, the frame being open to both sides of the vibrating member;
a first conical radiator attached to a first side of the vibrating member; and
a second conical radiator attached to a second side of the vibrating member.

18. The vibrating member assembly of claim 17, wherein the piezoelectric material is PZT.

19. A vibrating member assembly, comprising:
a plurality of parallel and rigidly mounted ribs, said ribs being generally planar and parallel, and having generally parallel upper edges;
a piezoelectric film bonded to and supported by the upper edges, said film curving intermediate the upper edges;
surface electrodes on opposite surfaces of said film; and
a peripheral frame supporting the ribs and the film, the frame being open to both sides of the film.

20. A vibrating member assembly, comprising:
an electrostatic transducer, comprising a polymer thin film; an electrode on one side of the film, and a metallic mesh on an opposite side of the film; and
a peripheral frame supporting the transducer, the frame being open on both sides of the transducer.

21. A vibrating member assembly, comprising:
a thickness mode transducer, comprising a planar piezoelectric layer, a first impedance matching layer on one side of the piezoelectric layer, and a second impedance matching layer on an opposite side of the piezoelectric layer;
a peripheral frame supporting the transducer, the frame being open on both sides of the transducer.

22. The assembly of claim 21, wherein said piezoelectric layer is of PZT.

23. The assembly of claim 21, wherein said piezoelectric layer is a ferro-electret film.
